(19) United States
(12) Patent Application Publication
(10) Pub. No.: US 2013/0016508 A1
(43) Pub. Date: Jan. 17, 2013

(54) VARIABLE THICKNESS GLOBE

(71) Applicants: CURT PROGL, Raleigh, NC (US); MARK DIXON, Morrisville, NC (US)

(72) Inventors: CURT PROGL, Raleigh, NC (US); MARK DIXON, Morrisville, NC (US)

(21) Appl. No.: 13/182,017

(22) Filed: Jul. 13, 2011

(51) Int. Cl. F21V 7/00; F21V 29/00; B23P 11/00; F21V 15/01

(52) U.S. Cl. 362/235; 362/362; 362/373; 29/428

(57) ABSTRACT

A variable thickness globe for a lighting device comprises a wall including a curved outer surface and an inner surface. A thickness of the wall between the curved outer surface and the inner surface varies over a predetermined extent of the wall.

### BACKGROUND

Aspects of the present invention relate to lighting, and more particularly to a variable thickness globe for ease of manufacturing and light distribution modification of a lighting device.

Globes or bulbs for lighting devices, such as a standard light bulb are formed with a wall that has a uniform or constant thickness throughout. The uniform thickness of the wall does not permit any diffusion or modification of light distribution from a light emitting element enclosed in the globe or bulb. To accomplish diffusion or light distribution effects with a uniform or constant thickness globe, surface effects such as texturing or spray-on coatings are used. Such surface effects require additional fabrication operations which can significantly increase the cost of production. Additionally, such surface effects can have limited impact and repeatability in a mass production environment.

### SUMMARY

According to one aspect of the present invention, a variable thickness globe for a lighting device may include a wall comprising a curved outer surface and an inner surface. A thickness of the wall between the curved outer surface and the inner surface varies over a predetermined extent of the wall.

According to another aspect of the present invention, a variable thickness globe for a lighting device may include a wall comprising a curved outer surface and an inner surface. The variable thickness globe may also include a base opening at one end of the wall for attachment to a base mounting platform of the lighting device for mounting a light emitting element. The inner surface of the wall may be substantially cylindrical from the base opening to a predetermined distance from the base opening. The variable thickness globe may include another opening opposite the base opening. The inner surface may be curved from the predetermined distance from the base opening to the other opening. A thickness of the wall between the outer surface and the inner surface varies over a selected length of the wall from the base opening to the other opening. The curved outer surface may include a predetermined curvature to cause a selected light distribution.

According to another aspect of the present invention, a lighting device may include a base mounting platform. A lighting element assembly may be mounted on the base mounting platform. A variable thickness globe may be attached to the base mounting platform and enclose the lighting element assembly. The variable thickness globe may include a wall including a curved outer surface and an inner surface. The inner surface may be linear along a predetermined portion its length. A thickness of the wall between the curved outer surface and the inner surface varies over a predetermined extent of the wall.

According to a further aspect of the present invention, a method for forming a lighting device may include forming a variable thickness globe. The globe comprises a wall including a curved outer surface and an inner surface. The inner surface being formed to allow removal of the die without a die-lock condition. A thickness of the wall between the curved outer surface and the inner surface varies over a predetermined extent of the wall. The method may also include providing a base mounting platform and mounting a lighting element assembly on the base mounting platform. The method further includes assembling the variable thickness globe on the base mounting platform and enclosing the lighting element assembly.

### BRIEF DESCRIPTION OF THE DRAWINGS

FIGS. 1A and 1B are different perspective views of an example of a variable thickness globe in accordance with an embodiment of the present invention.

FIG. 1C is a cross-section view of the exemplary variable thickness globe in FIGS. 1A and 1B.

FIG. 2 is a perspective view of another example of a variable thickness globe in accordance with another embodiment of the present invention.

FIG. 3A is a perspective view of an example of a lighting device in accordance with an embodiment of the present invention.

FIG. 3B is a cross-sectional view of the exemplary lighting device of FIG. 3A.

FIG. 4 is a flow chart of an example of a method for making a lighting device in accordance with an embodiment of the present invention.

### DETAILED DESCRIPTION

Embodiments of the present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element such as a layer, region or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

According to aspect of the present invention, a variable thickness globe for a light emitting diode (LED) lamp or other type lamp or lighting device allows for ease of manufacturing and light distribution modification. The variable thickness globe enables molding of a single piece globe that has both an upper and bottom opening. The globe includes a wall comprising a substantially straight or linear inner wall for ease of manufacturing and to prevent an injection molding lock condition or other manufacturing process difficulties and a curved outer wall that may include any features for desired light distribution. A molded-in diffuser may be used in the variable thickness globe to provide additional diffusion or hiding power around a central portion of the globe or globe belt line and less diffusion (better light transmission) around the upper and lower portions or edges of the globe. Such features are not possible with a constant thickness globe which requires the use of surface effects such as texturing or spray-on coatings which can have limited impact or repeatability concerns. The substantially straight or linear inner surface of the wall may also permit the implementation of lenticular features as described in more detail herein to modify light distribution. The variable thickness globe as described herein has multiple parameters that may be adjusted to improve the ability to obtain desired globe performance metrics.

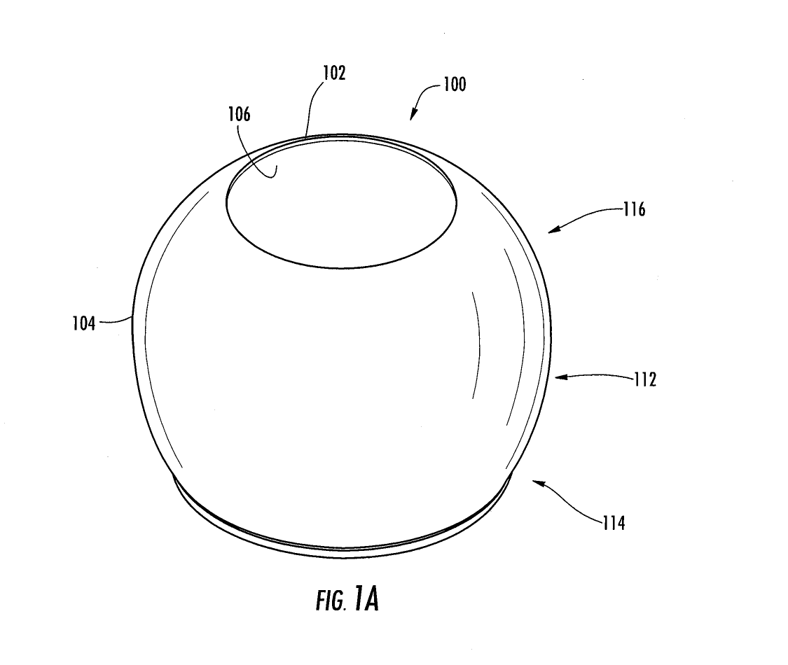

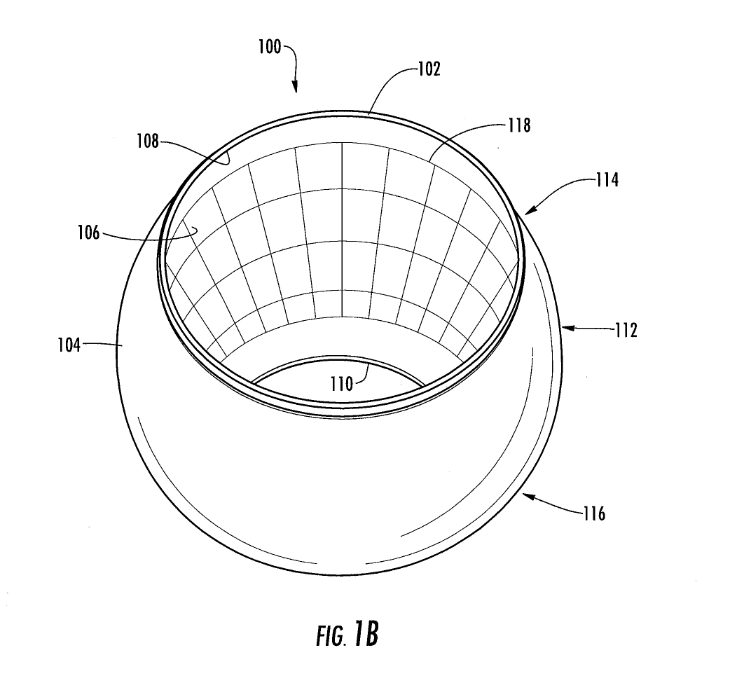

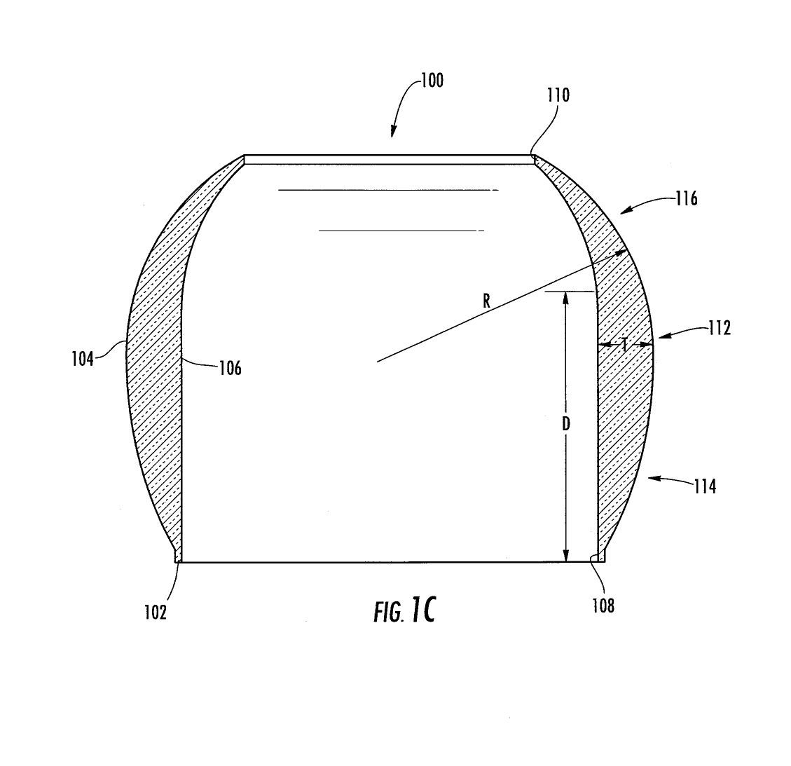

FIGS. 1A and 1B are different perspective views of an example of a variable thickness globe 100 in accordance with an embodiment of the present invention. FIG. 1C is a cross-section view of the variable thickness globe 100 in FIGS. 1A and 1B. The variable thickness globe 100 includes a wall 102. As best shown in FIG. 1C, the wall 102 includes n curved outer surface 104 and an inner surface 106. The inner surface 106 may be linear or straight along a predetermined portion of its length, for example over at least half of its length. In the exemplary embodiment illustrated in FIG. 1C, the inner surface 106 may be linear or straight over at least three fourths of its length. The outer surface 104 may be substantially spherically shaped although other embodiments may have different geometric shapes to provide different lighting effects or characteristics. The outer surface 104 may also be substantially smooth or without any asperities, such as those that may be associated with a Fresnel lens or other type lens or light distribution feature. A thickness “T” of the wall 102 between the outer surface 104 and the inner surface 106 may vary over a predetermined extent of the wall 102 or over substantially the entire extent of the wall.

In another embodiment, the outer surface 104 of the globe 100 may be shaped and sized corresponding substantially to a standard American National Standard Institute (ANSI) “A19” bulb or other ANSI bulb. A19 bulbs and other type bulbs are described in ANSI C78.20-2003 for electric lamps, A, G, PS, and Similar Shapes with E26 Screw Bases, Oct. 30, 2003, which is incorporated herein in its entirety by reference.

The variable thickness globe 100 may include a base opening 108 at one end of the wall 102 and another opening 110 opposite the base opening 108 at an opposite end of the wall 102. The base opening 108 may be larger than the other opening 110. The base opening 108 and the other opening 110 may each be circular, although either of the openings could be another geometric shape or design depending upon a particular design or application.

As described in more detail herein, the other opening 110 may act as a chimney to allow heated air to exhaust from an interior of a lighting device on which the globe 100 is installed.

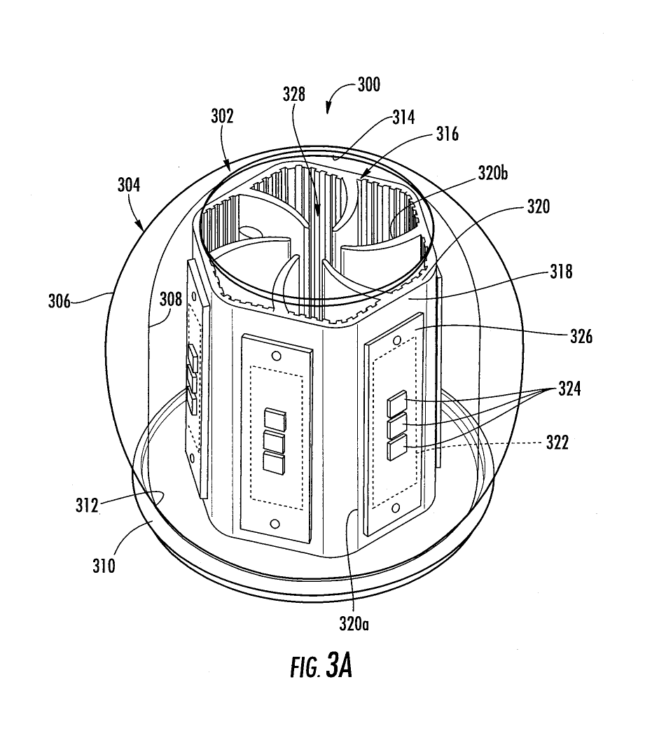

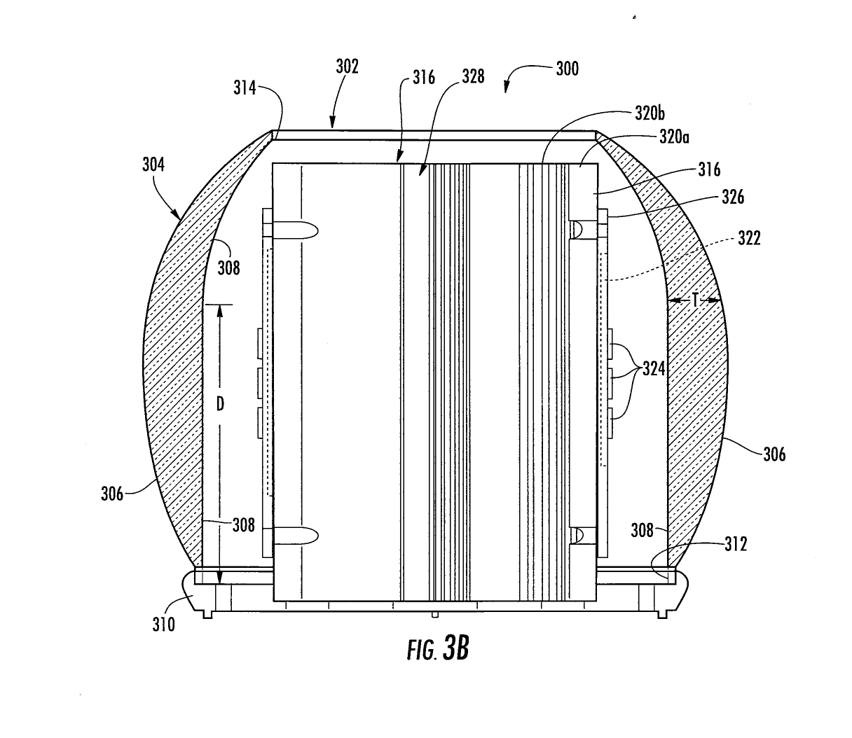

As described in more detail with reference to FIGS. 3A and 3B, the base opening 108 may be assembled on a base mounting platform or other support of a lighting device. The inner surface 106 of the wall 102 may be linear from the base opening 108 to a predetermined distance “D” (FIG. 1C) along the inner surface 106. In other words, the inner surface 106 of the wall 102 may be substantially cylindrical from the base opening 108 to the predetermined distance D from the base opening 108. The inner surface 106 may be curved or extend conically at some angle from a location at the predetermined distance D from the base opening 108 to the other opening 110. The thickness “T” of the wall 102 between the outer surface 104 and the inner surface 106 may vary over a selected length of the wall or over the entire length of the wall from the base opening 108 to the other opening 110. In other embodiments, there may be portions of the globe 100 where the wall has a uniform thickness over a selected length or area. This may be to provide a certain desired visual effect or characteristic. The globe 100 may be formed from a single piece of material. The material may be moldable material, such as an acrylic, polycarbonate or other material capable of forming a transparent or clear globe.

The curved outer surface 104 may include a predetermined curvature or radius of curvature “R” to provide a selected light distribution of light passing out of the globe 100 from a light emitting element (not shown in FIGS. 1A, 1B and 1C) enclosed in the globe 100. In other embodiments, the curved outer surface 104 may include multiple predetermined curvatures or radiuses of curvature or a varying radius of curvature along the length or extent of the wall 102 so as to provide different light distributions from different portions of the globe 100. For example, the curved outer surface 104 may have one radius of curvature around a beltline 112 or central section of the globe 100 and different radiuses of curvature on portions 114 and 116 on either side of the beltline 112 to cause a different distribution of light from the beltline 112 compared to the portions 114 and 116 of the globe 100. Depending upon the orientation of the globe 100, the portions 114 and 116 may be referred to as a lower portion and an upper portion or vice versa. In the orientation illustrated in FIG. 1C portion 114 may be the lower portion 114 and portion 116 may be the upper portion 116.

The variable thickness globe 100 may include a diffuser structure 118 to cause a predetermined diffusion of light passing out of the globe 100 from a light emitting element enclosed in the globe 100. A diffuser structure 118 may be formed as part of the wall 104. The diffuser structure 118 may be molded into the wall 104. For example the diffuser structure 118 may be molded in the inner surface 106 or formed on the inner surface 106 similar to that illustrated in FIG. 1B. In another embodiment, the diffuser structure 118 may be molded in or formed on the outer surface 104 or a combination of both the inner surface 106 and outer surface 104. The diffuser structure 118 may only be formed in or on a selected portion or portions of the globe 100. The diffuser structure 118 may also vary or may be different in different portions of the globe 110 or wall 102 to provide a different diffusion pattern to light energy passing through different portions of the globe 100, such as portions 112, 114 and 116 in FIG. 1C. The diffuser structure 118 may include a form to cause a higher diffusion of light around the beltline 112 of the globe 100 relative to the portions 114 and 116. Molded in diffusers may provide repeatable and consistent diffusion characteristics. Adjusting the variable thickness of the wall 102 between the base opening 108 and the other opening 110 may provide additional diffusion options or control in addition to a diffuser structure 118.

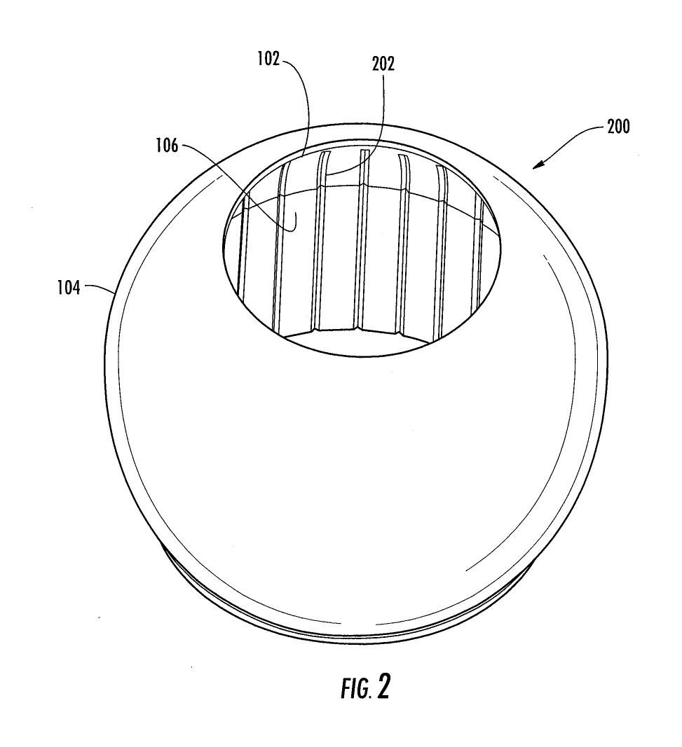

FIG. 2 is a perspective view of another example of a variable thickness globe 200 in accordance with another embodiment of the present invention. The variable thickness globe 200 may be similar to the globe 100 in FIGS. 1A, 1B and 1C. The globe 200 may include a lenticular feature 202 to cause a predetermined modification of the distribution of light passing out of the globe 200 from a light emitting element enclosed in the globe 200. The linear or straight inner surface 106 allows for the implementation of the lenticular features 202 to modify light distribution. The lenticular features 202 may vary in different portions of the globe 200 in order to provide different desired light distribution from the different portions.

FIG. 3A is a perspective view of an example of a lighting device 300 in accordance with an embodiment of the present invention. FIG. 3B is a cross-sectional view of the exemplary lighting device 300 of FIG. 3A. The lighting device 300 may include a variable thickness globe 302 that is the same or similar to the variable thickness globe 100 or 200 described with reference to FIGS. 1A, 1B, 1C and 2. Similar to that previously described, the variable thickness globe 302 may include a wall 304 including a curved outer surface 306 and an inner surface 308. The inner surface 308 may be linear or substantially cylindrical along at least half of its length. The thickness “T” (FIG. 3B) of the wall 304 between the curved outer surface 306 and the inner surface 308 varies over the extent or length of the wall 302.

The lighting device 300 may include a base mounting platform 310. The globe 302 includes a base opening 312 at one end of the wall 304 for attachment to the base mounting platform 310. The inner surface 308 of the wall 304 may be substantially cylindrical from the base opening 312 to a predetermined distance “D” (FIG. 3B) from the base opening 312. The globe 300 may also include another opening 314 opposite the base opening 312. The inner surface 308 may be curved from the predetermined distance “D” from the base opening 312 to the other opening 314.

A lighting element assembly 316 may be mounted on the base mounting platform 310. The lighting element assembly 316 may include a plurality of light emitting diode (LED) units 318. Each LED unit 318 may include a heat sink 320. Each LED unit 318 also includes an LED circuit board 322 attached to the heat sink 320 and in thermal communication with the heat sink 320 for transfer of heat from the LED circuit board 322 to the heat sink 320. A plurality of LEDs 324 may be formed or mounted on each LED circuit board 322. The LED circuit board 322 connects electrical power supplied to the lighting device 300 to the LEDs 324. Electrical power may be supplied to the lighting device 300 by any conventional means, such as a threaded screw type base or other electrical connector as may be know in the industry.

Each LED unit 318 may also include a reflector plate 326 attached to the heat sink 320. The reflector plate 326 covers the LED circuit board 322. The LEDs 324 may extend through openings formed in the reflector plate 322. The reflector plate 326 may be attached to the heat sink 320 by suitable fasteners, such as screws or another attachment arrangement. The reflector plate 326 provides protection for the LED circuit board 322 and reflects light from the LEDs 324 away from the lighting element assembly 316.

The LED units 318 may be mounted in a substantially circular pattern or a closed multisided loop pattern on the base mounting platform 310. The heat sink 320 may include a mounting plate portion 320a on which the LED circuit board 322 is mounted in thermal communication with the heat sink 320. The heat sink 320 may also include a member 320b extending from a back surface of the mounting plate portion 320a into a central portion 328 of the lighting device 300 as illustrated in FIG. 3A. The member 320b may have a predetermined curvature to provide additional surface area for transfer of heat from the heat sink 320. Air around the heat sink mounting plate portion 320a and member portion 320b may be heated by transfer of heat from the heat sink 320. The heated air may exhaust from the lighting device 300 through the other opening 314.

The heat sink 320 may also be a one piece heat sink with multiple sides 320a formed in a complete or closed loop. The member 320b may extend off a back side of each heat sink side 320a.

Another example of a lighting assembly that may be used in the lighting device 300 is described in U.S. patent application Ser. No. 12/683,886, U.S. Patent Publication No. 2011-0089830 filed Jan. 7, 2010, entitled “Heat Sink and Lamp Incorporating Same” (Docket No. P1062 US4) which is assigned to the assignee as the present application and is incorporated herein in its entirety by reference.

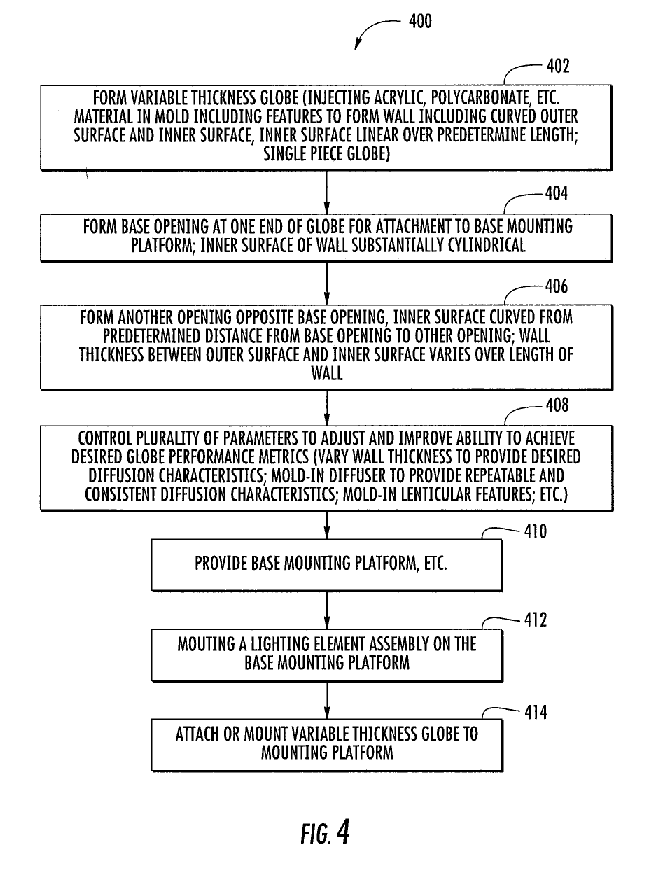

FIG. 4 is a flow chart of an example of a method 400 for making a lighting device in accordance with an embodiment of the present invention. In block 402, a variable thickness globe may be formed. The globe may be the same or substantially similar to the globe 100 or 200 described with reference to FIGS. 1A, 1B, 1C and 2. The globe may be formed by injection molding an acrylic, a polycarbonate or other moldable material capable of forming a transparent or clear globe. The mold or die may include features to form a wall of the globe including a curved outer surface and in the inner surface as described herein. The mold may also include features to form any diffuser structure or lenticular features as described herein. The inner surface of the wall may be formed to allow removal of a die without a die-lock condition, such as an injection molding die-lock condition or other manufacturing process difficulties. The inner surface of the wall may be substantially straight or linear over a predetermined portion of its length similar to that previously described. The globe may be formed as a single piece of material.

In block 404, a base opening may be formed at one and the globe for attachment to a base mounting platform of a lighting device. The base opening may be substantially circular and the inner surface of the wall may be substantially cylindrical from the base portion to a predetermined length or distance from the base opening.

In block 406, another opening may be formed opposite to the base opening. The inner surface of the wall may be curved from the predetermined distance from the base opening to the other opening. The other opening may also be substantially circular but may have other shapes in other embodiments, such as square or multisided. The base opening may also have other shapes as previously discussed.

In block 408, a plurality of parameters associated with fabricating or molding the globe may be controlled to provide selected or desired globe performance metrics or characteristics, such as diffusion of light, distribution of light and other optical effects. Examples of parameters that may be adjusted may include but is not necessarily limited to varying the wall thickness to provide desired diffusion characteristics; molding in a diffuser structure to provide repeatable and consistent light diffusion characteristics; and molding in lenticular features to provide desired repeatable and consistent optical affects of the globe.

In block 410, a base mounting platform or similar structure may be provided. In block 412, a lighting element assembly may be mounted on the mounting platform. The lighting element assembly may be similar to lighting element assembly 316 described with reference to FIGS. 3A and 3B.

In block 414 the variable thickness globe may be mounted or attached to the base mounting platform.

While the operations or steps in FIG. 4 are illustrated and described in a certain sequence, the present invention is not intended to be limited by the sequence or order illustrated. The steps and operations may be performed in any order unless otherwise specified. Some operations or steps may also be performed simultaneously or combined.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

1. A variable thickness globe for a lighting device, comprising a wall comprising a curved outer surface and an inner surface, wherein a thickness of the wall between the curved outer surface and the inner surface varies over a predetermined extent of the wall.

2. The variable thickness globe of claim 1, wherein the inner surface is linear along a predetermined portion of its length.

3. The variable thickness globe of claim 1, further comprising a base opening, wherein the inner surface is linear from the base opening to a predetermined length along the inner surface.

4. The variable thickness globe of claim 3, further comprising another opening opposite the base opening, wherein the thickness of the wall between the curved outer surface and the inner surface varies over the extent of the wall from the base opening to the other opening.

5. The variable thickness globe of claim 1, wherein the globe comprises a single piece of material.

6. The variable thickness globe of claim 1, wherein the curved outer surface comprises a predetermined radius of curvature to provide a selected light distribution.

7. The variable thickness globe of claim 1, further comprising a diffuser structure to cause a predetermined diffusion of light passing out of the globe from a light emitting element enclosed in the globe.

8. The variable thickness globe of claim 7, wherein the diffuser structure comprises a form to cause a higher diffusion of light around a beltline of the globe relative to a portion of the globe on either side of the beltline of the globe.

9. The variable thickness globe of claim 1, further comprising a lenticular feature to cause a predetermined modification of distribution of light passing out of the globe from a light emitting element enclosed in the globe.

10. The variable thickness globe of claim 1, wherein the outer surface comprises a varying radius of curvature along its extent to cause a different light distribution from different portions of the globe.

11. A variable thickness globe for a lighting device, comprising:
a wall comprising a curved outer surface and an inner surface;
a base opening at one end of the wall for attachment to a base mounting platform of the lighting device for mounting a light emitting element, wherein the inner surface of the wall is substantially cylindrical from the base opening to a predetermined distance from the base opening; and
another opening opposite the base opening, wherein the inner surface is curved from the predetermined distance from the base opening to the other opening, wherein a thickness of the wall between the curved outer surface and the inner surface varies over a selected length of the wall from the base opening to the other opening, and wherein the curved outer surface comprises a predetermined curvature to cause a selected light distribution.

12. The variable thickness globe of claim 11, wherein the wall comprises a diffuser structure to cause a predetermined diffusion of light passing out of the globe from a light emitting element enclosed in the globe.

13. The variable thickness globe of claim 11, wherein the wall comprises a lenticular feature to cause a predetermined modification of distribution of light passing out of the globe from a light emitting device enclosed in the globe.

14. A lighting device, comprising:
a base mounting platform;
a lighting element assembly mounted on the base mounting platform; and
a variable thickness globe attached to the base mounting platform and enclosing the lighting element assembly, the variable thickness globe comprising a wall including a curved outer surface and an inner surface, the inner surface being linear along a predetermined portion of its length, wherein a thickness of the wall between the curved outer surface and the inner surface varies over a predetermined extent of the wall.

15. The lighting device of claim 14, further comprising:
a base opening at one end of the wall for assembling on the base mounting platform, wherein the inner surface of the wall is substantially cylindrical from the base opening to a predetermined distance from the base opening; and
another opening opposite the base opening, wherein the inner surface is curved from the predetermined distance from the base opening to the other opening, wherein the thickness of the wall between the outer surface and the inner surface varies over a selected length of the wall from the base opening to the other opening, and wherein the curved outer surface comprises a predetermined curvature to cause a selected light distribution.

16. The lighting device of claim 14, wherein the base mounting platform comprises a heat sink.

17. The lighting device of claim 14, wherein the lighting element assembly comprises a plurality light emitting diode (LED) units, each LED unit comprising:
a heat sink;
an LED circuit board attached to the heat sink, a plurality of LEDs formed on the LED circuit board; and
a reflector plate covering the LED circuit board with each of the LEDs extending through an opening in the reflector plate.

18. The lighting device of claim 17, wherein the plurality of LED units are mounted in a substantially circular array on the base mounting platform.

19. The lighting device of claim 18, wherein the heat sink of each LED unit comprises:
a mounting plate on which the LED circuit board is mounted in thermal communication therewith; and
a member extending from a back surface of the mounting plate into a central portion of the lighting device.

20. The lighting device of claim 19, wherein the member of the heat sink comprises a curvature to provide additional surface area for transfer of heat from the heat sink.

21. A method for forming a lighting device, comprising:
forming a variable thickness globe, the globe comprising a wall including a curved outer surface and an inner surface, the inner surface being formed to allow removal of a die without a die-lock condition, wherein a thickness of the wall between the curved outer surface and the inner surface varies over a predetermined extent of the wall;
providing a base mounting platform;
mounting a lighting element assembly on the base mounting platform; and
assembling the variable thickness globe on the base mounting platform and enclosing the lighting element assembly.

22. The method of claim 21, wherein forming the variable thickness globe comprises:
forming a base opening at one end of the wall for attachment to the base mounting platform, wherein the inner surface of the wall is substantially cylindrical from the base opening to a predetermined distance from the base opening; and
forming another opening opposite the base opening, wherein the inner surface is curved from the predetermined distance from the base opening to the other opening, wherein the thickness of the wall between the curved outer surface and the inner surface varies over a selected length of the wall from the base opening to the other opening.

23. The method of claim 21, wherein forming the variable thickness globe comprises controlling at least one parameter.

24. The method of claim 21, wherein forming the variable thickness globe comprises curving the curved outer surface a predetermined curvature to cause a selected light distribution.

25. The method of claim 21, further comprising forming a diffuser structure to cause a predetermined diffusion of light passing out of the globe from the lighting element assembly.

26. The method of claim 21 further comprising forming a lenticular feature to cause a predetermined modification of distribution of light passing out of the globe from the lighting element assembly.
